(19) United States
(12) Patent Application Publication
(10) Pub. No.: US 2025/0102116 A1
(43) Pub. Date: Mar. 27, 2025

(54) SENSORIZED TURN TRAYS FOR CRYOGENIC STORAGE CONTAINERS

(71) Applicant: MVE Biological Solutions US, LLC, Brentwood, TN (US)

(72) Inventors: Jeff Brooks, Jasper, GA (US); Chris Payne, White, GA (US); Christina Ellis, Marietta, GA (US); Doug Wilcox, Cumming, GA (US); Brian Lauman, Dunedin, FL (US); Jeremy Corkran, Dunedin, FL (US); Will Stockdell, Woodstock, GA (US); David Fitzgerald, Acworth, GA (US); Jayrrd VAN ROOYEN, Jasper, GA (US); Bryan Borgerding, Marietta, GA (US)

(73) Assignee: MVE Biological Solutions US, LLC, Brentwood, TN (US)

(21) Appl. No.: 18/895,278

(22) Filed: Sep. 24, 2024

Related U.S. Application Data
(60) Provisional application No. 63/540,223, filed on Sep. 25, 2023.

(51) Int. Cl. F17C 13/02; F17C 3/08

(52) U.S. Cl. CPC F17C 13/02; F17C 3/085; F17C 2201/0119; F17C 2201/032; F17C 2203/0391; F17C 2223/0161; F17C 2250/032; F17C 2250/0478

(57) ABSTRACT

Cryogenic storage turn trays may be provided having a variety of sensors. The storage turn trays can have a sample storage area, a gear assembly, a shaft assembly, and a sensor assembly. The sensor assembly can be configured to measure movement of a sample storage area to determine a position of the sample storage area. Various indicators, displays, and/or annunciators may communicate the position of the sample storage area to a user.

### CROSS-REFERENCE TO RELATED APPLICATIONS

This application is based upon and claims priority to U.S. Provisional Patent Application No. 63/540,223 entitled “Sensorized Turn Trays for Cryogenic Storage Containers” and filed on Sep. 25, 2023, the entire content of which is incorporated herein by reference.

### TECHNICAL FIELD

This disclosure relates generally to turn trays for cryogenic storage containers and more specifically to cryogenic storage containers having turn trays with a location sensing feature.

### BACKGROUND

Cryogenic storage containers are often used for shipping and/or storage of temperature sensitive materials. When accessed, many containers will emit clouds of vapor (sometimes referred to as fog) that occlude their interior. This fog then prevents a user from identifying the turn tray location and timely locating their desired sample. Cryopreservatives and/or refrigerants (e.g., liquid N₂ or dry ice) can be added to a container to dissipate this fog, but this can quickly deplete reserves of refrigerant (e.g., cryopreservative) as containers are accessed and the fog is cleared.

### SUMMARY

In various embodiments, a system is provided. The system may include a cryogenic storage container. The system may include a human-machine interface (HMI) including a display, a processor, and a non-transitory memory. The cryogenic storage container may include a movable turn tray and a positional sensor. The non-transitory memory may store computing instructions configured to run on the processor and cause the processor to perform steps. For example, the processor may perform, in response to receiving a signal from the positional sensor indicating that the movable turn tray has moved, updating a human-machine interface (HMI) such as a graphical user interface (GUI) displayed on the display, the HMI illustrating an accessible area of the movable turn tray within the cryogenic storage container.

In various embodiments one or more further aspect is included. For example, the HMI may include a layout of the movable turn tray, an orientation of the movable turn tray within the cryogenic storage container, or a location of a requested sample on the movable turn tray. The HMI may include a graphical element indicating what areas of the movable turn tray are accessible through an opening in the cryogenic storage container. The movable turn tray may include a lazy Susan. The lazy Susan may have a plurality of rotating levels, wherein at least two levels of the plurality of rotating levels have different layouts. In various embodiments, the HMI includes current and historical levels for one or more of a temperature of an interior area of the cryogenic storage container and a refrigerant level of the cryogenic storage container.

A method may be provided. The method may be implemented via execution of computing instructions configured to run at one or more processors and configured to be stored at non-transitory computer-readable media. The method may include performing various aspects. For instance, the method may include in response to receiving a signal from a positional sensor indicating that a movable turn tray has moved, updating a human-machine interface (HMI) such as a graphical user interface (GUI) displayed on a display. The HMI may include a layout and orientation of the movable turn tray within a cryogenic storage container. The HMI may include a location of a requested sample on the movable turn tray. The HMI may include a graphical element indicating what areas of the movable turn tray are accessible through an opening in the cryogenic storage container.

One or more further aspect may be included. The movable turn tray may be a lazy Susan. The lazy Susan may have a plurality of rotating levels. At least two levels of the plurality of rotating levels may have different layouts. The HMI may include current and historical levels for one or more of a temperature of an interior area of the cryogenic storage container and a refrigerant level of the cryogenic storage container.

In various embodiments, an article of manufacture is provided. The article may include a non-transitory, tangible computer readable storage medium having instructions stored thereon that, in response to execution by a computer, cause the computer to perform operations. The operations may include in response to receiving a signal from a positional sensor indicating that a movable turn tray has moved, updating a human-machine interface (HMI) such as a graphical user interface (GUI) displayed on a display.

The article of manufacture may include other features. For instance, the HMI may include a layout and orientation of the movable turn tray within a cryogenic storage container. The HMI may include a location of a requested sample on the movable turn tray. The HMI may include a graphical element indicating what areas of the movable turn tray are accessible through an opening in the cryogenic storage container. In various embodiments, the movable turn tray includes a lazy Susan. The lazy Susan may have a plurality of rotating levels, wherein at least two levels of the plurality of rotating levels have different layouts. The HMI may include current and historical levels for one or more of a temperature of an interior area of the cryogenic storage container and a refrigerant level of the cryogenic storage container.

In various embodiments, a turn tray is provided for use in a cryogenic storage container. The turn tray may include various features. For instance, the turn tray may have a sample storage area. A shaft may be coupled to the sample storage area. A sensor may be configured to read the shaft to identify an orientation of the sample storage area.

One or more further aspects may also be provided. For instance, the sensor may be a capacitive proximity sensor, a time of flight sensor, or an electronic rotary sensor. The shaft may be a drop cam and the sensor is configured to read the drop cam. In various embodiments, the sensor is configured to determine when a peak of the drop cam is in front of the sensor. The shaft may be a spur gear and the sensor may be configured to read rotation of the spur gear. The turn tray may include tensioning system configured to hold a second spur gear against the spur gear. In various embodiments, the second spur gear is coupled to the sensor. The shaft may include a belt drive and the sensor is configured to read the belt drive. The shaft may include a drivetrain connecting the sample storage area to the shaft, the drivetrain configured to rotate the shaft when the sample storage area is moved. The drivetrain may include a spring-loaded detent ball. The spring-loaded detent ball couples to at least one of a ball bearing assembly of the drivetrain of the shaft and the shaft. In various embodiments, the drivetrain may include at least one of pins, screws, bolts, clamps, retainers, clips, splines to couple to at least one of a ball bearing assembly and the shaft.

A cryogenic storage container is provided. The container may include a movable turn tray and a sensor. The movable tray may have a plurality of compartments. The system may include a display coupled to the cryogenic storage container. The system may include a processor. The system may include a non-transitory memory storing computing instructions configured to run on the processor and cause the processor to perform aspects of a method. The method may include receiving, by the processor, data from the sensor. The method may include determining, by the processor, a position of the movable turn tray based on the data. The method may include generating, by the processor, a human-machine interface (HMI) such as a graphical user interface (GUI) on the display including a position of one or more compartments in the plurality of compartments.

In various embodiments, the cryogenic storage container further includes a lid coupled to the cryogenic storage container, the lid for retrieving a sample disposed in the cryogenic storage container. The HMI may include the position of the one or more compartments relative to the lid. The movable turn tray may include a shaft and a gear assembly. The sensor may be offset from the shaft by the gear assembly. The cryogenic storage container may include an inner housing and an outer housing. The shaft may extend through the inner housing and the outer housing. The shaft may include a drivetrain connecting a sample storage area to the shaft. The drivetrain may be configured to coordinate rotating the shaft when the sample storage area is moved. The cryogenic storage container may include a lid coupled to the cryogenic storage container. In various embodiments, determining the position of the movable turn tray includes determining the position of the plurality of compartments relative to the lid.

The non-transitory memory storing the computing instructions may be further configured to cause the processor to perform receiving, via the processor and through the HMI, a selected compartment in the plurality of compartments. The processor may further perform generating, via the processor and through the HMI, a position of the selected compartment relative to the lid.

A movable turn tray assembly is provided. The assembly may include a conduit. The assembly may include a shaft assembly disposed through the conduit, the shaft assembly extending from a first longitudinal end to a second longitudinal end and defining a longitudinal axis. The assembly may include a tray coupled to the shaft assembly adjacent the first longitudinal end. The assembly may include a gear assembly coupled to the shaft assembly adjacent the second longitudinal end. The assembly may include a sensor coupled to the gear assembly, the sensor being offset from the shaft assembly.

### BRIEF DESCRIPTION OF THE DRAWINGS

To facilitate further description of the embodiments, the following drawings are provided in which:

FIG. 1A illustrates a flowchart for a method, according to an embodiment;

FIG. 1B illustrates a further flowchart for a further method, according to an embodiment;

FIGS. 2A-2E illustrate user interfaces, according to certain embodiments;

FIGS. 3A-3C illustrates exterior views of a cryogenic storage container, according to an embodiment;

FIG. 4 illustrates a cross sectional view of a cryogenic storage container, according to an embodiment;

FIG. 5 illustrates an exploded view of shaft, sensor, and gear assemblies, according to an embodiment;

FIG. 6 illustrates a further exploded view of shaft, sensor, and gear assemblies, according to an embodiment;

FIG. 7 illustrates an exploded view of a shaft assembly, according to an embodiment; and

FIG. 8 illustrates an example sensor assembly with gears in accordance with various embodiments;

FIG. 9 illustrates an example sensor assembly with a belt, in accordance with various embodiments;

FIG. 10 illustrates an example sensor assembly with a chain, in accordance with various embodiments;

FIG. 11 illustrates aspects of an example sensor assembly with a drop cam for a time-of-flight sensor; and

FIG. 12 illustrates a drop cam in detail, in accordance with various embodiments.

For simplicity and clarity of illustration, the drawing figures illustrate the general manner of construction, and descriptions and details of some features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

### DESCRIPTION OF EXAMPLES OF EMBODIMENTS

Cryogenic storage containers are often used for shipping and/or storage of temperature sensitive materials. When accessed, many containers will emit clouds of fog that occlude their interior. This fog then prevents a user from identifying the turn tray location and timely locating a desired sample. Cryopreservatives and/or refrigerants (e.g., liquid N₂ or dry ice) can be added to a container to dissipate this cloud, but this can quickly deplete reserves of refrigerant (e.g., cryopreservative) as containers are accessed and the fog is cleared. Containers built to house multiple samples can exacerbate this problem, as users often need to search through the container to find a desired sample.

This disclosure provides different embodiments of a sensor mechanism to electronically indicate to a user which rack, turn tray section, sample, or group of samples is nearest an opening into the container, so that a user can more readily identify the location of a desired sample and retrieve that sample from the container, despite the presence of a view-occluding vapor cloud. Notably, sensorizing a cryogenic storage container has significant challenges, due to the low temperatures involved and need to maintain thermal integrity of the inner region of the container where the samples are stored. This disclosure provides for different systems to address these challenges.

A user can locate a sample of interest faster and easier than before when the sample's location is displayed on an HMI. The HMI can also update as a turn tray holding samples and/or holding racks that hold samples, moves, so that the sample of interest is moved within the cryogenic storage container. Furthermore, a user may interact with the system to select a sample of interest, then monitor visual indicators or audio annunciators for an indication that the sample of interest is moved to within reach of an opening of the container. In this way, a user can also save time by bringing the sample of interest within reach of an opening of the container before the container is opened.

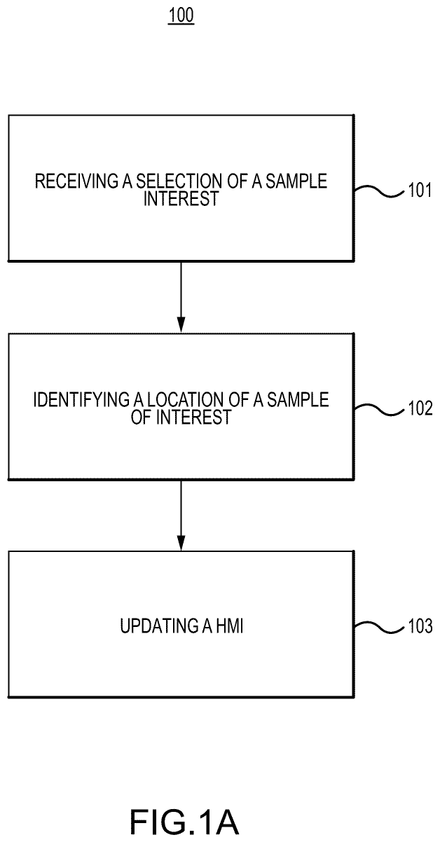

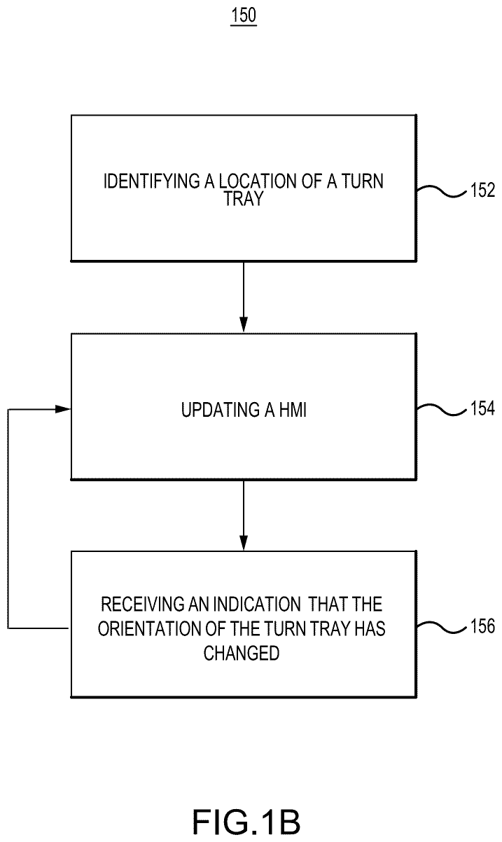

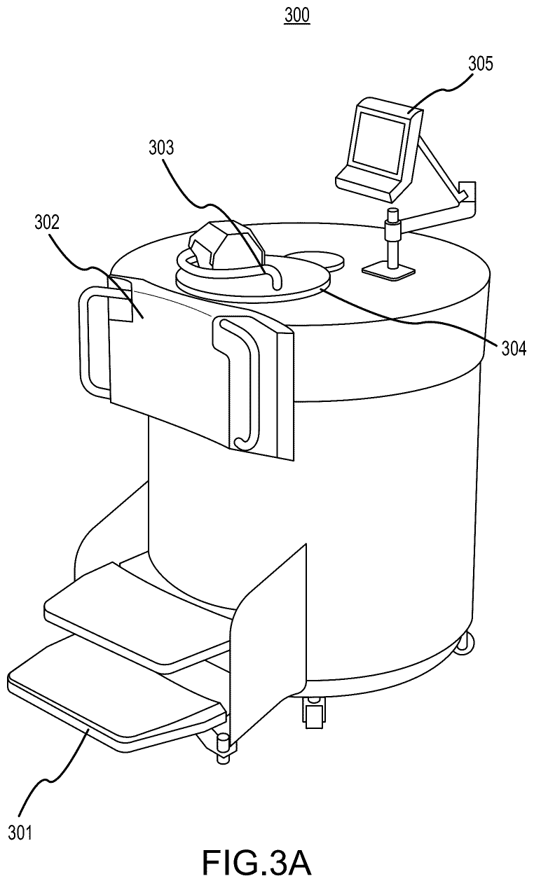

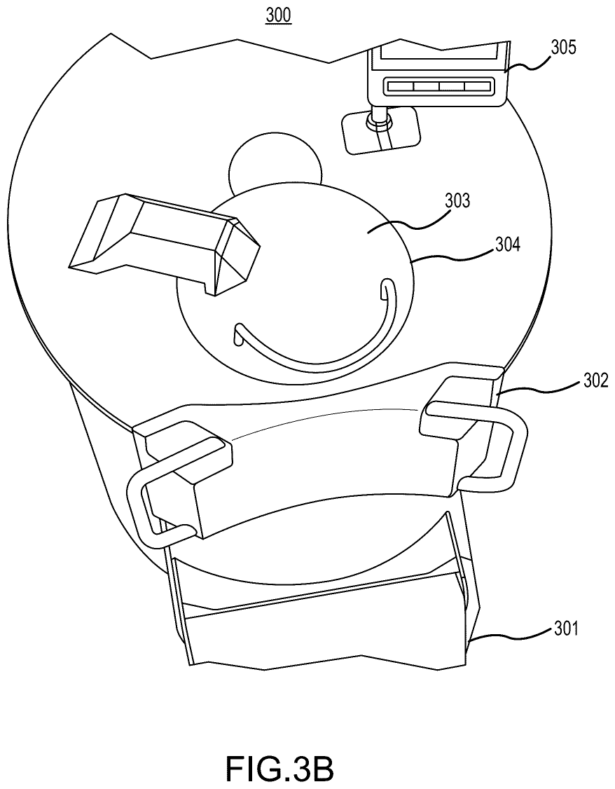

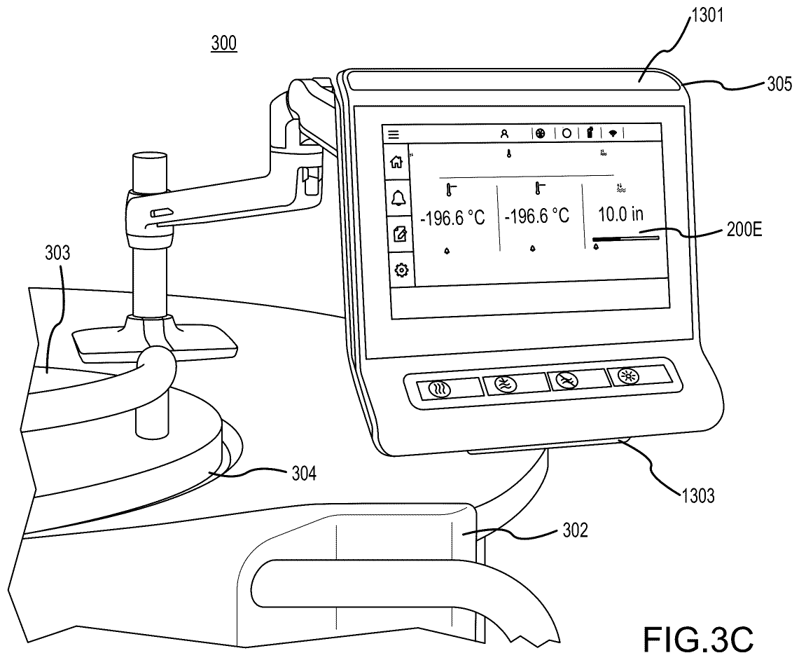

Before beginning a detailed discussion of embodiments of the system and apparatus that permits easier and faster location of a sample, a helpful discussion of how a user will interact with the system and the software implemented by the system, including a flow chart of a method associated with the system, should be provided. Turning now to the drawings, FIG. 1 illustrates a flow chart for a method 100, according to an embodiment. The method 100 is merely exemplary and is not limited to the embodiments presented herein. The method 100 can be employed in many different embodiments or examples not specifically depicted or described herein. In some embodiments, the activities of the method 100 can be performed in the order presented. In other embodiments, the activities of the method 100 can be performed in any suitable order. In still other embodiments, one or more of the activities of the method 100 can be combined or skipped. In many embodiments, a sensorized cryogenic storage container 300 (FIGS. 3A-C) can be suitable to perform the method 100 and/or one or more of the activities of the method 100. In these or other embodiments, one or more of the activities of the method 100 can be implemented as one or more computer instructions configured to run at one or more processing modules and configured to be stored at one or more non-transitory memory storage modules. Such non-transitory memory storage modules can be part of a computer system.

In many embodiments, the method 100 can comprise an activity 101 of receiving a selection of a sample of interest. A turn tray location can be identified by the user on a human-machine interface (HMI) such as a graphical user interface (GUI). A selection can be made on a human-machine interface (HMI) such as a graphical user interface (GUI). An HMI can be a part of and/or displayed by a computer system performing the method 100. With regards to form, the HMI can comprise text and/or graphics (image) based user interfaces. For example, the HMI can comprise a heads up display (HUD). When the HMI comprises a HUD, the HMI can be projected onto a medium (e.g., glass, plastic, metal, etc.), displayed as a hologram, and/or displayed on a display device 305 (FIGS. 3A-C). The HMI can be color, black and white, and/or greyscale. The HMI can be implemented as an application running on a computer system integrated into a cryogenic storage container, on a desktop computer, and/or on a mobile computer. In some embodiments, the HMI can be hosted on a server computer and can be delivered to another computer through a network (e.g., the Internet). For example, the HMI can comprise a tracking website for a shipment and/or a remote monitoring website for a cryogenic storage container. The HMI can receive a number of interactions from a user via an input device. For example, an interaction with the HMI can comprise a click, a look, a selection, a grab, a view, a purchase, a bid, a swipe, a pinch, a reverse pinch, etc. The HMI may include one or more indicator lights or may include one or more aural annunciators.

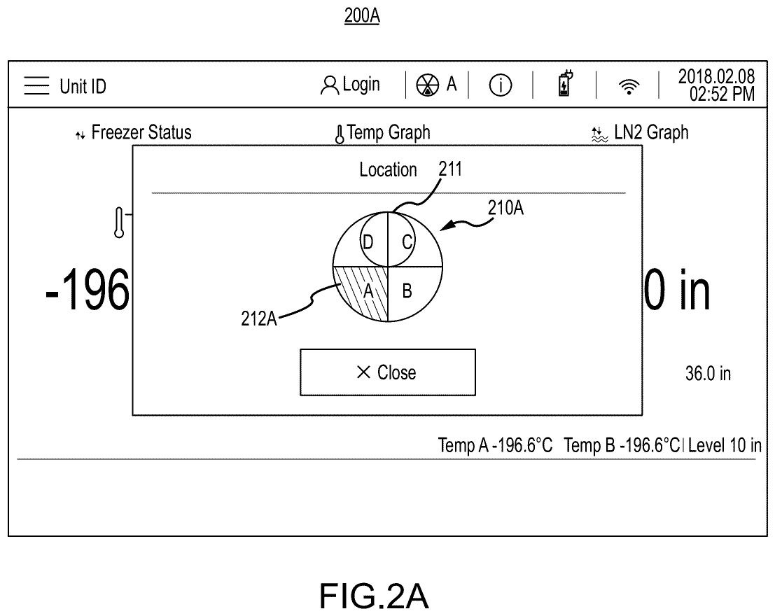

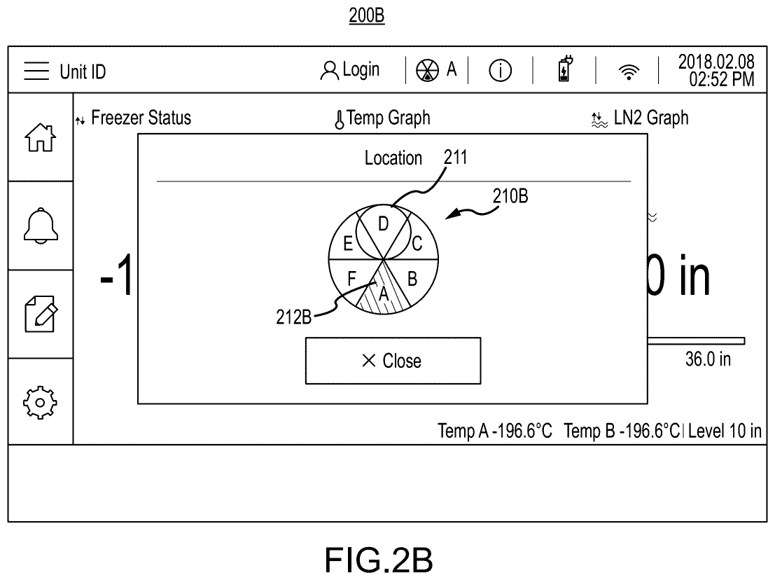

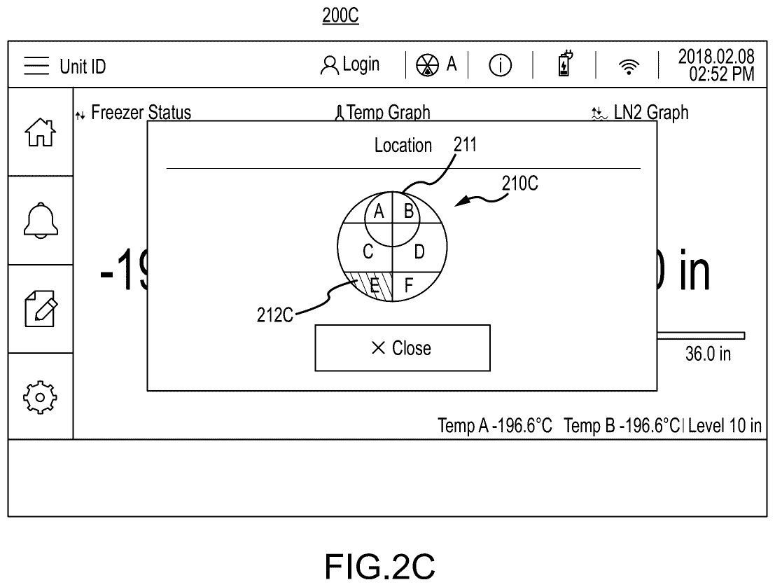

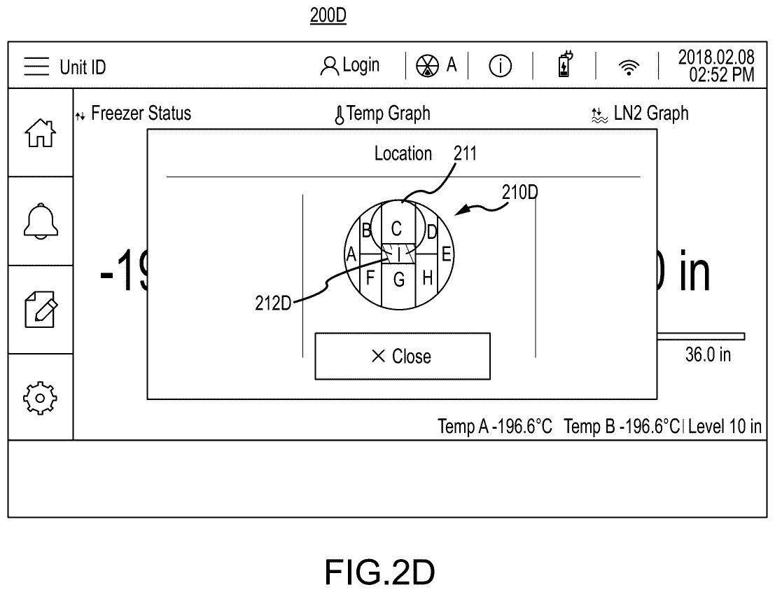

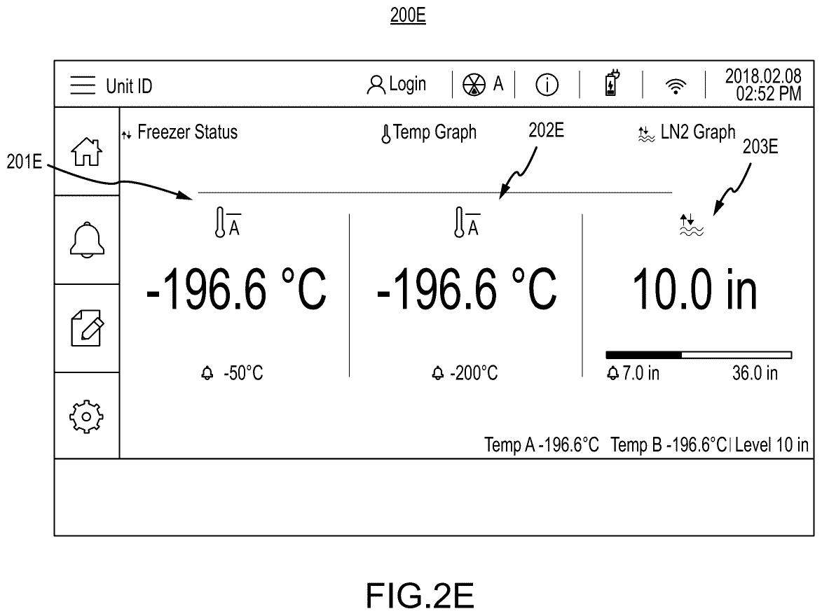

Turning ahead to FIGS. 2A-2D, a number of exemplary HMIs are shown. Each HMI 200A-200D can comprise a layout 210A-210D having one or more areas labeled A-I (if present in the respective layout). Areas within a layout can have a number of different shapes. For example, areas within layout 210A-210B are shaped like pie pieces. As another example, areas within layouts 210C-210D are shaped like rectangles and/or have a convex side. The HMIs 200A-D can also comprise an opening indicator 211 and/or turn tray section indicators 212A-212D. The opening indicator 211 can show which areas of a movable turn tray are accessible through an opening (e.g., opening 304 (FIG. 3A-C)) while turn tray section indicators 212A-212D can show a location of a sample of interest identified by a user. A movable turn tray can comprise one or more internal components of a sensorized storage container. For example, a movable turn tray can comprise a rotatable storage turn tray comprising one or more trays (commonly referred to as a lazy Susan). In some embodiments, the lazy Susan can have multiple levels.

Moreover, the GUI can be configured to scroll or transition between different layouts. Also, the HMI can be configured to scroll or transition between different layouts. With brief reference additionally to FIG. 3C, some aspects of the HMI are illustrated. For instance, a light bar 1301 may illuminate to indicate which direction the movable turn tray needs to be turned to move the sample of interest to an accessible location through the opening. For instance, selective illumination of the light bar 1301 may strobe or “paint” a moving light in one direction or another direction corresponding to a direction to turn the movable tray to bring the sample of interest to an accessible location. Furthermore, selective illumination of the light bar 1301 may indicate a remaining degree of movement of the turn tray needed to register the sample of interest under the opening 304. In further instances, a second indicator light 1303 may illuminate to indicate that the sample of interest has achieved registration under the opening 304. Similarly, audio indicators may be included. For instance, an aural annunciator may vary a frequency, duty cycle, amplitude, or other characteristics of an annunciation to indicate a remaining degree of movement or a direction of movement of the turn tray needed to register the sample of interest under the opening 304, as well as to indicate when the sample of interest has achieved registration under the opening 304.

In various embodiments, a light bar 1301 or a second indicator light 1303 may exhibit a strobing effect to indicate that the turn tray should be turned to a first direction or a second opposite direction to register the sample of interest under the opening 304. In various embodiments, an audio alert may be generated when the sample of interest is registered under the opening 304. An audio alert may be generated each time a different section, such as a section depicted as areas labeled A-I or otherwise (see FIGS. 2A-2D) is registered under the opening 304. This may aid awareness of the turn tray orientation during movement of the turn tray. Moreover, one or more indicator, whether on the light bar 1301, or second indicator light 1303, or other aspect of the HMI may change color depending on whether the sample of interest is registered under the opening 304 or whether an associated section such as sections depicted as areas labeled A-I (see FIGS. 2A-2D) is registered under the opening 304. The light bar 1302 or second indicator light 1303 or other aspect of the HMI may change colors, with different colors associated with different sections (such as sections depicted as areas labeled A-I) being registered under the opening 304.

As used herein, to register a sample of interest under the opening 304 may include detecting a position of a sample of interest. However, in other embodiments, registering the sample of interest under the opening 304 may include detecting a position of the turn tray and registering a section, such as a section depicted as areas labeled A-I or otherwise (see FIGS. 2A-2D), under the opening 304. Thus different levels of precision may be provided. Moreover, registration of the sample of interest may be detected by detecting an orientation of the turn tray, or by using a sensor to sense a sample and measure a location of the sample (e.g., RFID or MEMS based sensing), integration with inventory tracking systems, or the like.

In further embodiments, the HMI illustrates an opening indicator 211 and a map of turn tray section indicators 212A-212D, that updates to illustrate the orientation of the turn tray section indicators 212A-212D relative to the opening indicator 211 but that does not indicate a selection of any specific region of the turn tray or any associated sample.

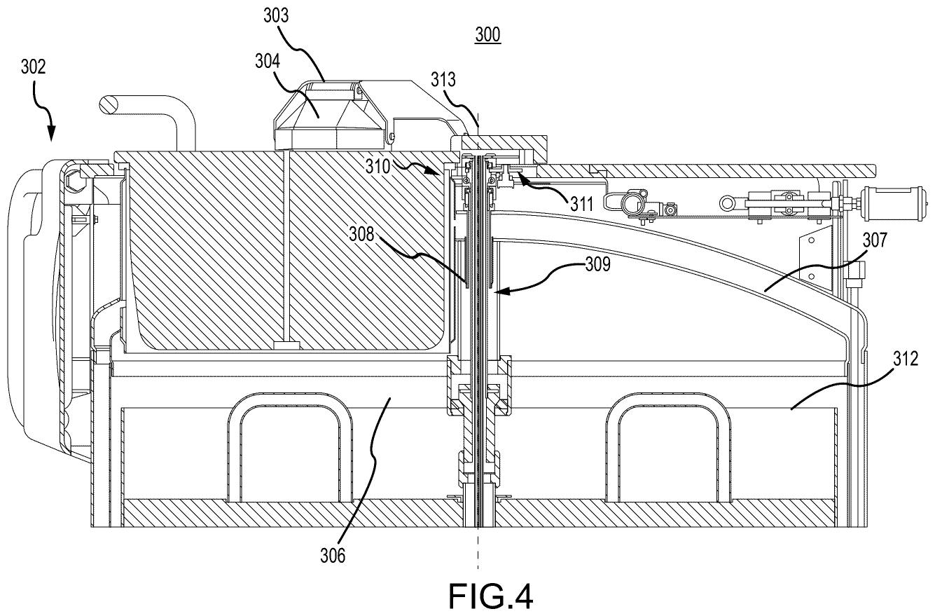

The opening indicator 211 and/or turn tray section indicators 212A-212D can be overlaid over any areas to reflect real world conditions within a cryogenic storage container. In this way, users can access the container knowing an orientation of a turn tray within the container. This, in turn, can lower the time needed when searching for a sample of interest and conserve cryopreservative and/or refrigerant in a reservoir 307 (FIG. 4). The HMI 200E can give operating information about a connected container. The HMI 200E can comprise a current reading for temperature in different areas 201E, 202E and/or a cryopreservative and/or refrigerant level 203E. Other HMIs not shown can comprise a graph for temperature over time and/or a graph for a cryopreservative and/or refrigerant level over time.

Returning now to FIG. 1A and with continuing reference to FIGS. 2A-D, the method 100 can comprise an activity 102 of identifying a location of the sample of interest in a movable turn tray. Areas highlighted by turn tray section indicators 212A-212D (FIGS. 2A-D) can be generated by querying a database to determine a location of a sample of interest or by sensing a location of a sample of interest such as via RFID sensing or MEMS-based sensing. The database can comprise a sample database that contains information about where samples are stored in a container. The database may contain data corresponding to a sample identifier and data corresponding to an associated location of the sample in the container. The HMI (such as GUI, light bar 1301, second light indicator 1303, or aural annunciator) may direct a user to move the turn tray until the sample is adjacent to an opening of the container. For example, the HMI may present various movement indicators directing a user to adjust the rack in specific directions. In other instances, the HMI illustrates an orientation of the turn tray and—as the user manipulates the turn tray-illustrates changing orientations of the turn tray so that an indication is provided on the HMI corresponding to which portion of the turn tray is adjacent to the opening. In further instances, the database may omit data corresponding to a sample identifier but may contain data corresponding to types of samples stored in different regions of the turn tray. In these embodiments, the HMI can direct a user to move the turn tray until the type of sample or a specific sample is adjacent to an opening of the container. The GUI, or as mentioned in prior paragraphs, and with reference to FIG. 3C, the light bar 1301, or second light indicator 1303, or aural annunciator may direct a user to move the turn tray until the type of sample or the specific sample is adjacent to an opening of the container. Thus, one may appreciate that many different configurations of databases may be useful in different embodiments.

The databases can be stored on one or more memory storage devices (e.g., non-transitory memory storage module(s)). Further, the one or more databases can each be stored on a single memory storage device of the memory storage device(s), and/or the non-transitory memory storage device(s) storing the one or more databases or the contents of that particular database can be spread across multiple ones of the memory storage device(s) and/or non-transitory memory storage device(s) storing the one or more databases, depending on the size of the particular database and/or the storage capacity of the memory storage device(s) and/or non-transitory memory storage device(s). In various embodiments, databases can be stored in a cache for immediate retrieval on-demand. The one or more databases can each comprise a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, IBM DB2 Database, and/or NoSQL Database.

In many embodiments, the method 100 can comprise an activity 103 of updating a human-machine interface (HMI), such as a GUI. Updating the HMI may include updating an indication on a computer screen display, or it may include illuminating one or more indicator, or (though reference to a graphical user interface is made). It may include an aural indication such as by an annunciator. In many embodiments, an HMI can be updated to show or otherwise indicate a location of the sample of interest. Once a location of a sample of interest is returned, a corresponding area of a sample layout can be modified. For example, in the HMIs 200A-200D, an area for a sample of interest is highlighted in specific a color and/or shade. Other modifications (e.g., animation, patterns, sound, etc.) can also be used. In various embodiments, an HMI can be updated to communicate a position of a movable turn tray. In many embodiments, a position of a movable turn tray can be shown relative to an opening (e.g., opening 304 (FIGS. 3A-C)). A position of a movable turn tray can be generated by taking an output from sensor assembly (e.g., sensor assembly 311 (FIG. 4)) and using it to determine a rotational position of a sample turn tray. A layout of the HMI can then be rotated a corresponding number of degrees and/or a position of opening indicator 211 (FIGS. 2A-2D) can be changed so the HMI is accurate.

With reference to FIG. 1B, in various embodiments, a further method 150 is provided. The method 150 may comprise identifying a location of a turn tray (block 152). For instance, a sensor may be queried to determine an orientation of the turn tray relative to an opening. The method may include updating an HMI (block 154). For instance, the HMI may be updated to communicate the orientation of the turn tray relative to an opening. The method may include receiving an indication from a sensor that the orientation of the turn tray relative to the opening has changed to a new orientation (block 156). The method may include then returning to block 154 to cause the HMI to update to show the new orientation.

Having generally discussed different ways the system can operate and different ways a user can interact with an operating system, this discussion now turns to structures of the sensorized cryogenic storage container. Turning ahead in the drawings, FIGS. 3A-C illustrate an exemplary embodiment of a sensorized cryogenic storage container 300. The sensorized cryogenic storage container 300 is merely exemplary and is not limited to the embodiments presented herein. The sensorized cryogenic storage container 300 can be employed in many different embodiments or examples not specifically depicted or described herein. In some embodiments, the elements of the sensorized cryogenic storage container 300 can be coupled in the arrangement presented. In other embodiments, the elements of the sensorized cryogenic storage container 300 can be coupled in any suitable arrangement. In still other embodiments, one or more of the elements of the sensorized cryogenic storage container 300 can be combined or omitted. In various embodiments, the sensorized cryogenic storage container 300 is a cryogenic freezer such as may be disclosed in U.S. patent application Ser. No. 16/182,878, filed Nov. 7, 2018, and entitled “CRYOGENIC FREEZER,” which is incorporated by reference herein in its entirety. Similarly, the sensorized cryogenic storage container 300 may be a cryogenic freezer such as may be disclosed in U.S. Prov. Pat App. No. 62/627,557 and filed Feb. 2, 2018, or as disclosed in Japanese Patent Application No. 2017-214614, filed Nov. 7, 2017, both of which are also incorporated by reference herein in their entireties.

The sensorized cryogenic storage container 300 can comprise steps 301, pad 302, cover 303, and/or a display device 305. The sensorized cryogenic storage container 300 may include a light bar 1301 and/or a second indicator light 1303. The light bar 1301 and/or second indicator light 1303 may be a part of display device 305. An annunciator may also be provided. The annunciator may also be a part of display device 305 and may be disposed internally therein (not shown in FIG. 3A-3C). Steps 301 can allow a user to get a better angle of view for opening the cover 303 and/or looking into the opening 304. The pad 302 can protect a user from a cold surface of sensorized cryogenic storage container 300 while at the same time providing the user with a cushioned edge to lean on. The opening 304 can provide access to a sample storage area 306 (FIG. 4) while the cover 303 can be configured to at least partially seal the sample storage area 306 (FIG. 4) from an exterior environment. The display device 305 can comprise any human-machine interface (HMI) and may have a computer display capable of displaying an HMI such as a GUI (e.g., LCD, LED, smart ink, etc.). For example, FIG. 3C shows the display device 305 displaying the HMI 200E.

Turning now to FIG. 4, a cross sectional view of the sensorized cryogenic storage container 300 is shown with the display device 305 removed. The sensorized cryogenic storage container 300 can further comprise the sample storage area 306, a reservoir 307, a shaft assembly 309, a gear assembly 310, a sensor assembly 311, and/or a turn tray 312. The sample storage area 306 can contain one or more samples (e.g., a sample of interest) stored in a movable turn tray (e.g., a lazy Susan). The turn tray 312 can be within the sample storage area 306 and connected to aspects of the shaft assembly 309. In this way, when the turn tray 312 is rotated, the shaft assembly 309 causes aspects of the sensor assembly 311 to also rotate. In many embodiments, the sample storage area 306 can comprise a movable turn tray having a layout similar to that displayed on one or more of HMIs 200A-200D (FIGS. 2A-2D).

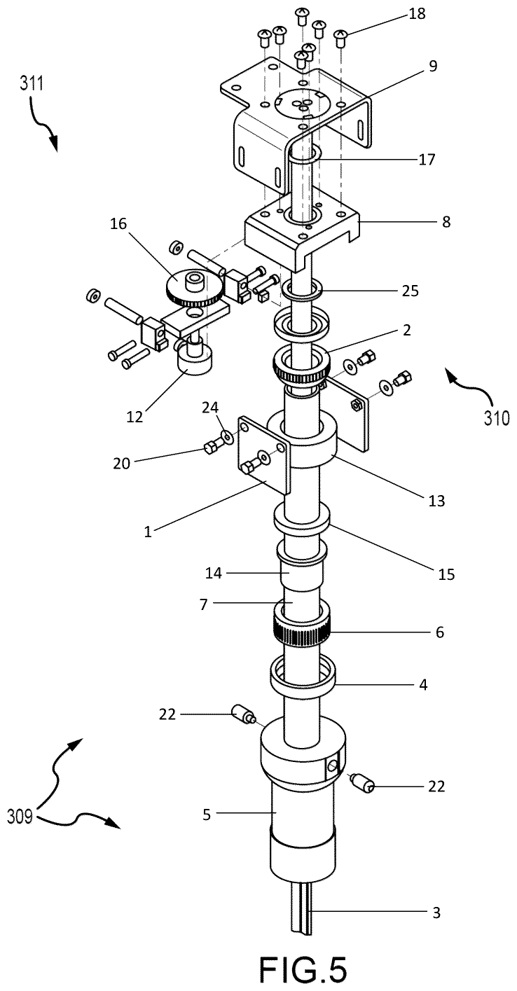

The reservoir 307 can comprise an inner area of a vessel, such as a double-walled vessel having an insulative material and/or at least partial vacuum space between the walls. The reservoir 307 may be configured to contain cryopreservative that cools the sample storage area 306. In some embodiments, the reservoir 307 can be configured with one or more sensors to detect and report refrigerant levels to a computer system. The container 300 may have a conduit 308. The conduit 308 may comprise a cylindrical structure, tubular structure, or other shape of channel-like passage that can run longitudinally along an axis 313 through the sensorized cryogenic storage container 300 and provide room for one or more of the shaft assembly 309, the gear assembly 310, and/or the sensor assembly 311. In some embodiments, the conduit 308 can be electrically and/or thermally insulated from an exterior environment to protect machinery and electronics within the conduit 308 from damage and/or to ameliorate potential thermal leakage. The shaft assembly 309 can comprise components comprising and/or mechanically coupled to a shaft 7 (FIG. 5) running longitudinally along the axis 313 through the sensorized cryogenic storage container 300. The shaft assembly 309 can be coupled to and/or mechanically linked to one or more of the turn tray 312 of the sample storage area 306, the gear assembly 310, and/or the sensor assembly 311. The gear assembly 310 can comprise one or more gears configured to transfer rotational motion between one or more of the turn tray 312 of the sample storage area 306, the shaft assembly 309, and/or the sensor assembly 311. In some embodiments, the gear assembly 310, the shaft assembly 309, and/or the sensor assembly 311 can share and/or have complementary sets of gears for transferring rotational motion between each other.

Turning now to FIG. 5, an exploded view of the shaft assembly 309, the gear assembly 310, and the sensor assembly 311 is shown. The shaft assembly 309 may run longitudinally through the conduit 308 (FIG. 4). The shaft assembly 309 can comprise a temperature sensor tube 3, the shaft 7 at least partially encapsulating the temperature sensor tube 3, a ball bearing assembly 5, and/or one or more spring plunger 22. In many embodiments, the temperature sensor tube 3 can run down an approximately centerline of the shaft assembly 309. The temperature sensor tube 3 can be a most interior portion of the shaft assembly 309 and can couple directly to the sensor assembly 311 and/or be mechanically linked to the sensor assembly 311. In various embodiments, the temperature sensor tube 3 remains non-rotational, while the shaft 7 rotates concentrically about the temperature sensor tube 3 passing through an inside of the shaft 7. In this manner, the shaft 7 may transmit a rotational position of the turn tray 312 (FIG. 4) for a position sensor, while the temperature sensor tube 3 remains stationary to secure wires for a temperature sensor. In many embodiments, the shaft assembly 309 can be topped by one or more caps and/or cap assemblies configured to allow the shaft 7 to rotate freely while keeping it oriented longitudinally within the conduit 308 (FIG. 4). For example, a mount plate 9 can be secured with one or more fasteners 18 to the shaft assembly 309 via a block 8. A bracket 1 and a fastener 20 can also be used to secure the shaft assembly 309 within the conduit 308 (FIG. 4). The shaft assembly 309 can also comprise additional parts configured to allow portions of the shaft assembly 309 to freely rotate. For example, the shaft assembly 309 can comprise one or more flanges 4, washers 24-25, one or more seals 15, one or more O-rings 17, and/or one or more bushings 14. The O-rings can further function to aid in the insulation (both electrical and thermal) of elements within the conduit 308 (FIG. 4). The shaft assembly 309 can further compromise the ball bearing assembly 5 and the one or more spring plunger 22, which are described in further detail below.

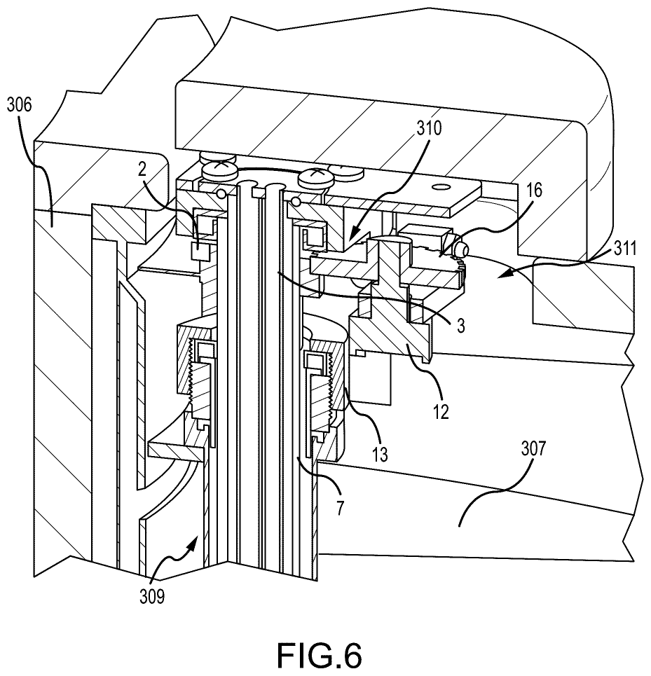

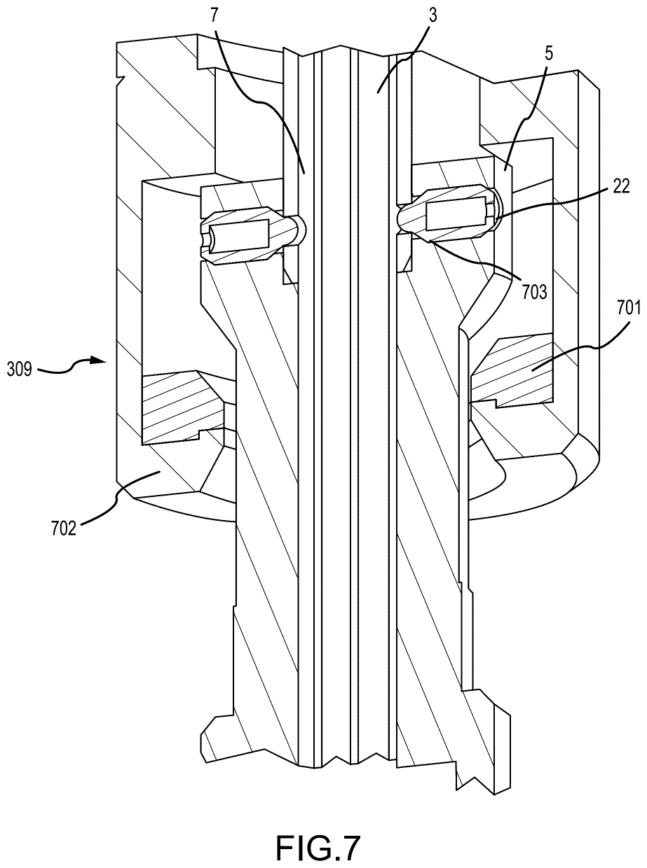

Turning now to FIG. 6, but with occasional continuing reference to FIG. 5, a cross sectional view of at top portion of the shaft assembly 309, the gear assembly 310, and the sensor assembly 311 is shown. The shaft assembly 309 can further comprise a plug 13. The plug 13 can be positioned underneath the sensor assembly 311 and be configured to at least partially seal the sensor assembly 311 within a conduit. The gear assembly 310 can comprise a shaft spur gear 2 coupled to the shaft 7. The sensor assembly 311 can comprise a rotary sensor 12 and/or a spur gear 16. The shaft 7 can begin underneath the cap and extend to the ball bearing assembly 5 and attach to the ball bearing assembly 5 to transmit rotation of the ball bearing assembly 5 as a turn tray rotates, to the rotary sensor 12. The temperature sensor tube 3 can have a different length in various embodiments. The shaft 7 can have an approximately tube-like shape and can fully or partially encapsulate the temperature sensor tube 3. While not seen in FIG. 6, the shaft 7 can comprise one or more cutout 703 (FIG. 7) that receive one or more spring plungers 22 (FIG. 7) to facilitate mechanically linking the ball bearing assembly 5 (FIG. 5) and thus the turn tray 312 (FIG. 4) to the shaft 7. A shaft spur gear 2 can be coupled to and/or around the shaft 7 such that both turn in unison and/or as one piece. The shaft spur gear 2 can interlock with the spur gear 16, thereby mechanically linking the shaft assembly 309 with sensor assembly 311. The spur gear 16 can, in turn, be coupled to and turn the rotary sensor 12. In this way, when the shaft 7 rotates in response to movement from the turn tray 312 (FIG. 4) in the sample storage area 306 (FIG. 4), the rotary sensor 12 is also rotated. The rotary sensor 12 then generates a signal for delivery to and interpretation by a computer system.

Turning now to FIG. 7, a cross sectional view of a lower portion of the shaft assembly 309 is shown. In many embodiments, the ball bearing assembly 5, the spring plunger 22, a bearing 701, and/or the bracket 702 can work in concert to couple and/or mechanically link the shaft assembly 309 with the turn tray 312 (FIG. 4) in the sample storage area 306 (FIG. 4). In this way, movement of the turn tray 312 (FIG. 4) can be transferred through the shaft 7 and to a sensor. The turn tray 312 (FIG. 4) can couple to and/or be mechanically linked with the ball bearing assembly 5 while the bearing 701 can prevent the ball bearing assembly 5 from sliding out of the bracket 702. The bracket 702, in turn, can be fixed to an interior of a cryogenic storage container so that it can support a weight of the turn tray 312 (FIG. 4). In some embodiments, the ball bearing assembly 5 and/or the spring plunger 22 can comprise a spring-loaded detent ball or a similar locking mechanism. This locking mechanism can then couple with the shaft 7 via a cutout 703. The shaft 7 can be made of fiberglass or some other insulating material. When locked, the ball bearing assembly 5 can couple to and/or rotate with the shaft 7. In this way, rotational motion can be transferred up through the shaft assembly 309 and to the sensor assembly 311 (FIG. 4).

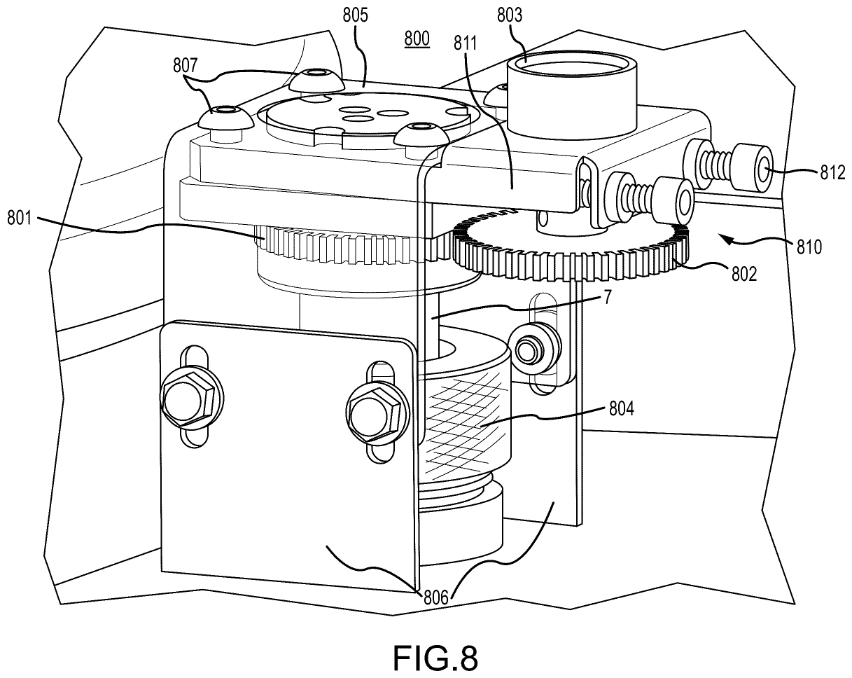

Turning now to FIG. 8, a sensor assembly 800 is shown. In many embodiments, the sensor assembly 800 can be used in place of and/or in addition to the sensor assembly 311 (FIG. 4). The sensor assembly 800 can sometimes be referred to as a gear drive sensor assembly due to the use of gears (e.g., gear 801 and/or gear 802) for transferring rotational motion from the shaft 7 to a sensor 803. In many embodiments, the sensor 803 can comprise an electronic rotary sensor. The electronic rotary sensor can comprise a sensor configured to use electric signals to transmit rotational positions to a computer system. A number of different rotary sensors can be used as the sensor 803. For example, the sensor 803 can comprise a rotary potentiometer, a magnetic hall effect sensor, a rotary encoder, a rotary inductive position sensor, a rotary variable differential transformer sensor, and many other types of electronic rotary sensors. The sensor 803 can read the shaft 7 by measuring an angular rotation of the shaft 7 via the sensor 803. The sensor assembly 800 can also comprise a tensioning system 810. The tensioning system 810 can be configured to adjust a tension between the gear 801 and the gear 802. Tension between the gear 801 and the gear 802 can be adjusted by adjusting a length of one or more of tension screws 812. The tension screws 812 can be screwed either towards or away from the shaft 7 to position the gear 802 at a distance from the gear 801 that allows enough clearance for the gear 801 and the gear 802 to engage and rotate. A cap 805 (shown as transparent) can be placed above and in-line with the shaft 7 and/or the gear 801. Fasteners can be used to secure the cap 805 in place as well as to the bracket 806.

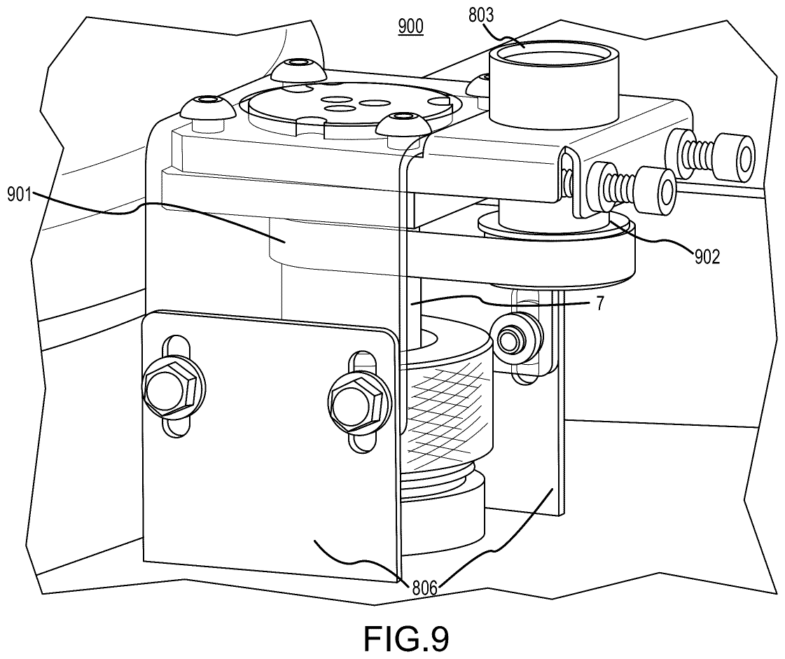

Turning now to FIG. 9, a sensor assembly 900 is shown. In many embodiments, the sensor assembly 900 can be used in place of and/or in addition to the sensor assembly 311 (FIG. 4). The sensor assembly 900 can be similar to the sensor assembly 800 (FIG. 8), but instead of using the gear 801 (FIG. 8) and the gear 802 (FIG. 8), a belt 901 and a sensor hub 902 are used. The sensor assembly 900 can sometimes be referred to as a belt drive sensor assembly due to the use of the belt 901 and the sensor hub 902 for transferring rotational motion from the shaft 7 to the sensor 803.

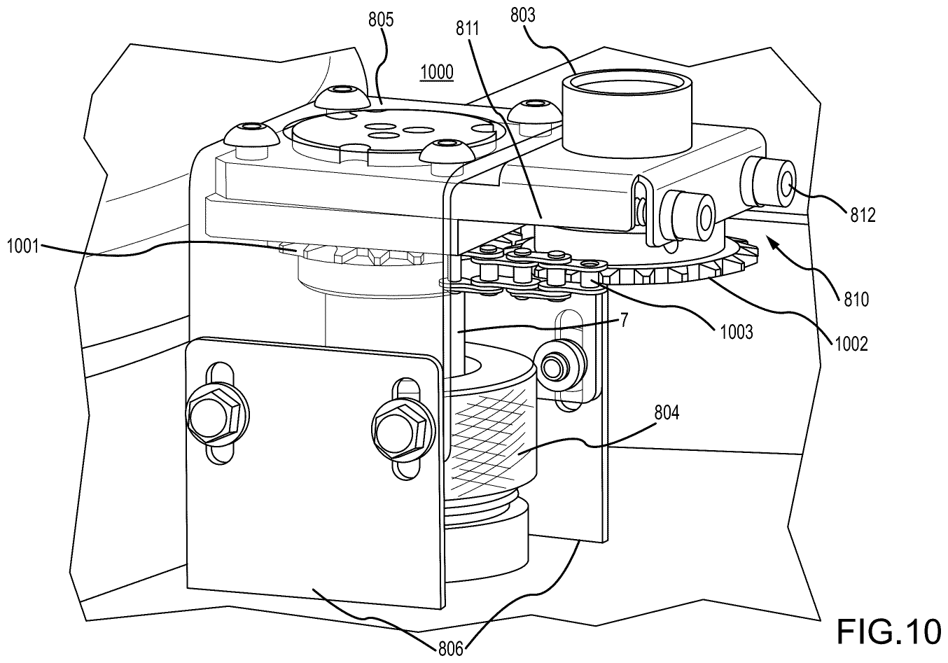

Turning now to FIG. 10, a sensor assembly 1000 is shown. In many embodiments, the sensor assembly 1000 can be used in place of and/or in addition to the sensor assembly 311 (FIG. 4). The sensor assembly 1000 can be similar to the sensor assembly 800 (FIG. 8), but instead of using the gear 801 (FIG. 8) and the gear 802 (FIG. 8), a gear 1001, a gear 1002, and a chain 1003 are used. The sensor assembly 1000 can sometimes be referred to as a chain drive sensor assembly due to the use of the gear 1001, the gear 1002, and the chain 1003 for transferring rotational motion from the shaft 7 to the sensor 803.

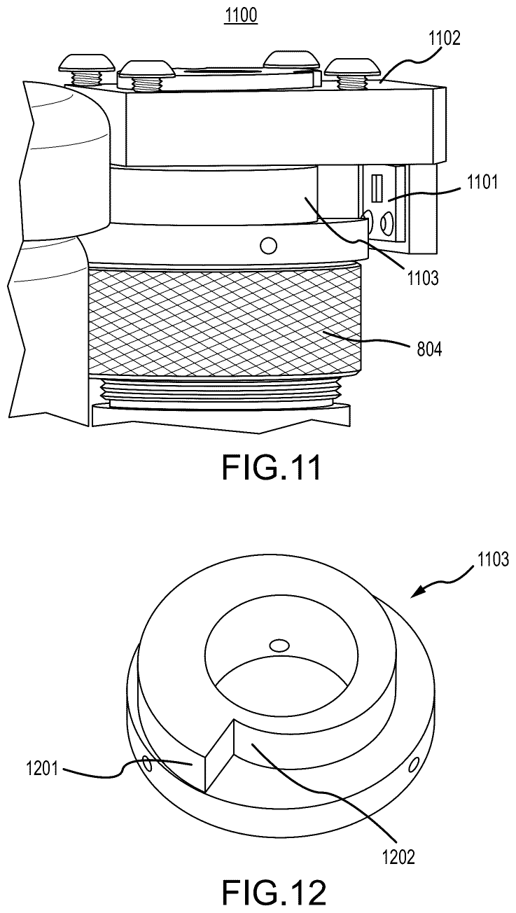

Turning now to FIGS. 11 and 12, a sensor assembly 1100 is shown. In many embodiments, the sensor assembly 1100 can be used in place of and/or in addition to the sensor assembly 311 (FIG. 4). The sensor assembly 1100 can sometimes be referred to as a time-of-flight sensor assembly due to the use of a time-of-flight sensor 1101 and/or a drop cam 1103. The time-of-flight sensor 1101 can comprise an optical sensor configured to use light rays to read degrees of rotational motion of the shaft 7. The time-of-flight sensor 1101 can shine light rays (e.g., laser light) onto the drop cam 1103. The time-of-flight sensor 1101 can then record an amount of time it takes for the light to reflect off of the drop cam 1103 and return to the time-of-flight sensor 1101. This reflection time is increased as drop cam rotates from a peak 1201 to a drop 1202 due to the decrease in height from the peak 1201 to the drop 1202. A reflection time or a difference between two reflection times can then be used to compute a rotational position of the drop cam 1103 and therefore the shaft 7 (not shown). In some embodiments, a cap 1102 can be used to secure the time-of-flight sensor 1101 in place.

With reference to FIGS. 1A-12, one example implementation of the turn tray assembly may include aspects such as a conduit, a shaft assembly disposed through the conduit, the shaft assembly having two ends, a first longitudinal end and a second longitudinal end, and the shaft assembly defining a longitudinal axis between the two longitudinal ends. The assembly also including a tray, such as a turn tray, coupled to the shaft assembly adjacent to the first longitudinal end. A gear assembly may be coupled to the shaft assembly adjacent to the second longitudinal end and a sensor may be coupled to the gear assembly. The sensor may be offset from the shaft assembly.

One may appreciate that certain aspects of the disclosure may be characterized by a series of numbered sentences. For instance, various methods and articles of manufacture may be provided. Consider the following numbered sentences.

1. A method implemented via execution of computing instructions configured to run at one or more processors and configured to be stored at non-transitory computer-readable media, the method comprising: in response to receiving a signal from a positional sensor indicating that a movable turn tray has moved, updating a human-machine interface (HMI), the HMI comprising a layout and orientation of the movable turn tray within a cryogenic storage container.

2. The method of sentence number 1, wherein the HMI further comprises a location of a requested sample on the movable turn tray.

3. The method of sentence number 1, wherein the HMI further comprises a graphical element indicating what areas of the movable turn tray are accessible through an opening in the cryogenic storage container.

4. The method of sentence number 1, wherein the HMI comprises at least one of (i) an indicator light and (ii) an annunciator.

5. The method of sentence number 1, wherein the movable turn tray comprises a lazy Susan and wherein the lazy Susan has a plurality of rotating levels, wherein at least two levels of the plurality of rotating levels have different layouts.

6. The method of sentence number 1, wherein the HMI further comprises current and historical levels for one or more of a temperature of an interior area of the cryogenic storage container and a refrigerant level of the cryogenic storage container.

7. An article of manufacture including a non-transitory, tangible computer readable storage medium having instructions stored thereon that, in response to execution by a computer, cause the computer to perform operations comprising: in response to receiving a signal from a positional sensor indicating that a movable turn tray has moved, updating a human-machine interface (HMI), the HMI comprising a layout and orientation of the movable turn tray within a cryogenic storage container.

8. The article of manufacture of sentence number 8, wherein the HMI further comprises a location of a requested sample on the movable turn tray.

9. The article of manufacture of sentence number 8, wherein the HMI further comprises a graphical element indicating what areas of the movable turn tray are accessible through an opening in the cryogenic storage container.

10. The article of manufacture of sentence number 8, wherein the movable turn tray comprises a lazy Susan.

11. The article of manufacture of sentence number 10, wherein the lazy Susan has a plurality of rotating levels, wherein at least two levels of the plurality of rotating levels have different layouts.

12. The article of manufacture of sentence number 8, wherein the HMI further comprises current and historical levels for one or more of a temperature of an interior area of the cryogenic storage container and a refrigerant level of the cryogenic storage container.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real time” encompasses operations that occur in “near” real time or somewhat delayed from a triggering event. In a number of embodiments, “real time” can mean real time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately one second, two seconds, five seconds, or ten seconds.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

Although sensorized turn trays for cryogenic storage containers have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-12 may be modified, and that the foregoing discussion of certain of these embodiments does not necessarily represent a complete description of all possible embodiments. For example, one or more of the procedures, processes, or activities of FIG. 1 may include different procedures, processes, and/or activities and be performed by many different modules, in many different orders.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
a cryogenic storage container comprising a movable turn tray and a positional sensor;
a human-machine interface (HMI) including a display;
a processor; and
a non-transitory memory storing computing instructions configured to run on the processor and cause the processor to perform in response to receiving a signal from the positional sensor indicating that the movable turn tray has moved, updating the human-machine interface (HMI), the HMI indicating an accessible area of the movable turn tray within the cryogenic storage container.

2. The system of claim 1, wherein the HMI further comprises a layout of the movable turn tray, an orientation of the movable turn tray within the cryogenic storage container, or a location of a requested sample on the movable turn tray.

3. The system of claim 1, wherein the HMI further comprises a graphical element indicating what areas of the movable turn tray are accessible through an opening in the cryogenic storage container.

4. The system of claim 1, wherein the movable turn tray comprises a lazy Susan, wherein the lazy Susan has a plurality of rotating levels, wherein at least two levels of the plurality of rotating levels have different layouts.

5. The system of claim 1, wherein the HMI further comprises current and historical levels for one or more of a temperature of an interior area of the cryogenic storage container and a refrigerant level of the cryogenic storage container.

6. A turn tray for use in a cryogenic storage container, the turn tray comprising:
a sample storage area;
a shaft coupled to the sample storage area; and
a sensor configured to read the shaft to identify an orientation of the sample storage area.

7. The turn tray of claim 6, wherein the sensor comprises a capacitive proximity sensor, a time of flight sensor, or an electronic rotary sensor.

8. The turn tray of claim 6, wherein the shaft comprises a drop cam and the sensor is configured to read the drop cam, wherein the sensor is configured to determine when a peak of the drop cam is in front of the sensor.

9. The turn tray of claim 6, wherein the shaft comprises a spur gear and the sensor is configured to read rotation of the spur gear, and further comprising a tensioning system configured to hold a second spur gear against the spur gear, wherein the second spur gear is coupled to the sensor.

10. The turn tray of claim 6, wherein the shaft comprises a belt drive and the sensor is configured to read the belt drive.

11. The turn tray of claim 6, wherein the shaft comprises a drivetrain connecting the sample storage area to the shaft, the drivetrain configured to rotate the shaft when the sample storage area is moved.

12. The turn tray of claim 11, wherein the drivetrain comprises a spring-loaded detent ball, wherein the spring-loaded detent ball couples to at least one of a ball bearing assembly of the drivetrain of the shaft and the shaft.

13. A system comprising:
a cryogenic storage container comprising a movable turn tray and a sensor, the movable turn tray including a plurality of compartments;
a display coupled to the cryogenic storage container;
a processor; and
a non-transitory memory storing computing instructions configured to run on the processor and cause the processor to perform:
receiving, by the processor, data from the sensor;
determining, by the processor, a position of the movable turn tray based on the data; and
generating, by the processor a graphical user interface (GUI) on the display including a position of one or more compartments in the plurality of compartments.

14. The system of claim 13, wherein the cryogenic storage container further comprises a lid coupled to the cryogenic storage container, the lid for retrieving a sample disposed in the cryogenic storage container, wherein the GUI further comprises the position of the one or more compartments relative to the lid.

15. The system of claim 13, wherein the movable turn tray further comprises a shaft and a gear assembly, and wherein the sensor is offset from the shaft by the gear assembly.

16. The system of claim 15, wherein the cryogenic storage container further comprises an inner housing and an outer housing, the shaft extending through the inner housing and the outer housing.

17. The system of claim 15, wherein the shaft comprises a drivetrain connecting a sample storage area to the shaft, the drivetrain configured to coordinate rotating the shaft when the sample storage area is moved.

18. The system of claim 13, wherein the cryogenic storage container further comprises a lid coupled to the cryogenic storage container, and wherein determining the position of the movable turn tray further comprises determining the position of the plurality of compartments relative to the lid.

19. The system of claim 18, wherein the non-transitory memory storing the computing instructions is further configured to run on the processor and cause the processor to perform:
receiving, via the processor and through the GUI, a selected compartment in the plurality of compartments; and
generating, via the processor and through the GUI, a position of the selected compartment relative to the lid.

20. A movable turn tray assembly, comprising:
a conduit;
a shaft assembly disposed through the conduit, the shaft assembly extending from a first longitudinal end to a second longitudinal end and defining a longitudinal axis;
a tray coupled to the shaft assembly adjacent the first longitudinal end;
a gear assembly coupled to the shaft assembly adjacent the second longitudinal end; and
a sensor coupled to the gear assembly, the sensor being offset from the shaft assembly.
